(19) United States
(12) Patent Application Publication
(10) Pub. No.: US 2002/0120551 A1
(43) Pub. Date: Aug. 29, 2002

(54) Visual-kinesthetic interactive financial trading system

(76) Inventor: Clarkson Jones III, Charlotte, NC (US)

Correspondence Address: SUMMA & ALLAN, P.A., 11610 NORTH COMMUNITY HOUSE ROAD, SUITE 200, CHARLOTTE, NC, 28277, US

(21) Appl. No.: 09/794,776

(22) Filed: Feb. 27, 2001

(51) Int. Cl. G06F 17/60

(52) U.S. Cl. 705/37; 705/36

(57) ABSTRACT

A visual-kinesthetic system for financial trading is disclosed. The system includes a computer with at least one screen that has both input and output capabilities, graphical software controllable by input to the computer that follows and plots the movement of financial information in a market to the input/output screen, and trading software controllable by the computer and by input from the screen that functionally communicates with the graphical software so that interaction with graphical information on the screen can control the trading software.

### FIELD OF THE INVENTION

The present invention relates to the buying and selling (“trading”) of various securities in the public markets. In particular, the invention relates to an improved apparatus and software combination for trading securities more quickly and efficiently based upon the information presented.

### BACKGROUND OF THE INVENTION

The present invention relates to the trading of securities in public markets. Methods of trading securities in public markets have their roots in transactions going back literally centuries, but in recent decades the invention relates most closely to the ability to make trades electronically; i.e. by transmitting an order using a computer when that computer is in turn connected (such as by telephone) to a source which could make the trade. In particular, the growth of the global computer network (“Internet”) in recent years, and the use of graphical interfaces on the World Wide Web, when combined with the progress in the development and function of the personal computer from about 1980 to date, has created the capability for individuals working at personal computers that are connected to the World Wide Web to make real time trades on the public securities markets using browser-based software. As used herein, the term “browser” is used in its ordinary recognized sense; i.e. a computer program that enables a user to read hypertext in files or on the World Wide Web, e.g. Downing, Dictionary of Computer and Internet Terms, 6^{th} Ed. (1998), Barron's.

Although the mechanics of trading securities is well known to those of ordinary skill in this art, and currently to many laymen, a brief review in conjunction with typical current technology will be instructive. First, the trader needs to identify the particular security (or other financial instrument) for which he or she wishes to make a trade. Then, the trader needs to decide on the price at which the security is to be bought or sold, and in what amount. There are numerous additional factors that can be considered or incorporated, such as the decision to sell short, sell long (more typically) or to place bid, market or limit orders, and many others.

Accordingly, FIG. 1 is illustrative of a prior art screen 10 that is typically available from an “on-line” broker. The screen 10 in FIG. 1 would generally be referred to as a quote screen because it shows the prices (“Quote”) at which a stock is currently trading. Thus, in FIG. 1, the price 11 is listed near the left hand side of the screen approximately one-third of the way from the bottom and indicates that the stock of the XYZ Company has last traded at a price of 4 1/32.

FIG. 1 also shows the exchange symbol 12 (“XYZ”), the bid price 13, and the ask price 14. Because FIG. 1 represents a typical browser-based trading screen, it also shows the browser toolbar 15 and various HTML (hyper text mark up language) links, one of which (for Quotes/Charts/News) is designated at 16. In short summary, a typical screen such as 10 provides a great deal of information, but not the means for acting upon it.

In order to track the trend of a stock price, which in many circumstances is a quite valuable pattern of information, the customer or trader must move to a different screen such as is illustrated at 20 in FIG. 2. In order to do so the trader would have to find the spot (link) on the screen of FIG. 1 at which the browser can be redirected to the chart from the quote screen, or alternatively use the quote look up screen made available by the symbol look up window 17 in FIG. 1.

FIG. 2 illustrates a chart screen 20 , which as illustrated is typical of a “pop-up” window in a browser/HTML environment. The quote chart 20 shows a 50 day moving average for a stock price, and those familiar with such presentations will recognize that other rolling time periods can be selected, from as long as a year or more (e.g. weekly prices) to as short as the current day. Within the chart 20, the movement of a stock's price on a given day is illustrated by a vertical bar 21 for which the length represents the high and low trading prices on a given day. Thus, like the chart of FIG. 1, the chart of FIG. 2 offers valuable information about the price and history of a given stock, but fails to provide any means of acting upon that information. Such acting depends again upon finding and using yet another screen.

Accordingly, an ordering screen is illustrated at 27 in FIG. 3. Such an ordering screen 27 typically requires that a number of items be input, mostly by typing. These include the stock symbol 30, the action desired 31, the quantity 32, the type of order 33, the timing of the order 34, certain optional activities or conditions 35, and a final submission of the order 36. Finishing the order, however, requires some other type of physical input action to indicate the type of order, and the timing. Furthermore, the information illustrated in FIGS. 1 and 2 remains unavailable while the actions required to use the screen in FIG. 3 are being carried out.

Stated differently, evaluating and placing an order using such a typical system requires navigation (including connection delays) between and among several “web pages,” data entry from a keyboard, and potentially data entry from another device, such as a mouse. Admittedly, many mouse commands can be emulated or duplicated using keyboard commands, but these are typically more complex than ordinary keyboard commands, and exacerbate the input problem rather than relieving it.

Because financial information, particularly information that follows the securities markets, is a function of variables that include both time and price information, much of the information is typically followed in a visual manner; i.e., using charts and graphs. Thus, some information can be plotted or charted as simply as the price of a security over a certain period of time, such as days, weeks, or even as short as hours or minutes. Thus, a very basic form of chart is referred to as the line chart, which simply plots price against time and connects the time intervals and prices with a line on a period-by-period basis.

In a slightly more sophisticated version, the data can be plotted as a bar chart or various versions thereof. A daily or weekly bar chart follows the price movement of a stock in a day (or a week). The bar chart also indicates the highest and lowest price of a stock during the particular period measured, along with the closing price. Accordingly, bar charts offer some additional information about the short-term trend of a stock. In almost all cases, a bar chart consists of two segments of a line with a vertical line drawn between the highest lowest price with a short horizontal bar to the right of the vertical indicating the closing price.

Yet, a third type of common chart is referred to as the moving average. The moving average chart plots the average price of a stock over a specified previous period of time (e.g., thirty days) as points on a line calendar. Thus, the moving average chart tends to moderate the visual appearance of extreme fluctuations and give a longer-term trend. Stated differently, the moving average is a line that joins the average closing price of a stock of a predetermined time interval. For example, a ten-day moving average shows the last ten days' average closing price. For traders, the principal use of the moving average is to develop information about the support and resistance level of a stock. The relationship between the daily price and the moving average gives investors information upon which they may decide to buy or sell a stock.

There are many other ways to plot such financial information. A candlestick chart is related to a bar chart, but is either filled or empty, depending upon the relationship between the opening or closing price of a stock (i.e., moves up or down during the day).

The information provided by a simple line or bar chart can be further developed to produce information such as convergence/divergence, stochastics, momentum, relative strength, and Bollinger bands among others.

The value of using charts as a method of interpreting the performance of securities, and in turn acting upon such information, is well understood in the industry. For example, Murphy, The Visual Investor (1996) John Wiley & Sons, Inc. gives a thorough discussion of the development of chart information and its potential use by an investor or trader.

Charted information has other value as well. In particular, it is generally well recognized in the educational arts that persons tend to learn in slightly different manners from one another. This tends to be noted relatively early, such as in primary school age groups, but is also reflected in the manner in which a person learns throughout their lifetime. Thus, some persons are referred to as “visual learners”, a term that generally refers to persons who tend to learn best by seeing words and numbers printed in text form, by using graphics and pictures, observing real life objects and events, and using maps, charts, graphs, and other visual aids.

“Auditory learners” are those who tend to learn best by listening and talking. They take in information best through their sense of hearing and learn by listening to other persons present information orally and by being allowed to discuss the topic and ask questions.

“Kinesthetic learners” tend to learn best through movement of their large or motor muscles. They tend to take in information best when moving. Learning activities include actually doing the taught subject matter, involvement in projects, role playing, real life activities, and learning while standing up or using the large muscles to write, for example as on a large surface such as a chalkboard or flipchart.

“Tactile learners” tend to learn best through their sense of touch, such as by using their hands and fingers. They tend to learn best by writing, drawing, taking notes, using hands-on manipulatives, and involving their emotions and feelings while learning.

Accordingly, because market and financial information can be so valuably presented in visual format and because visual and kinesthetic and tactile learners will respond best in a fashion different from auditory and other learners, there exists a need for devices and methods which can incorporate the skills of visual and kinesthetic learners as they deal with information that could also be presented in strictly text format (e.g., the financial section of a major newspaper).

### OBJECT AND SUMMARY OF THE INVENTION

Therefore, it is an object of the present invention to provide a computer-based system for trading stocks and other financial instruments that presents information in visual format and allows trading to be carried out quickly and easily on the basis of the visually-presented information.

The invention meets this object with a visual-kinesthetic system for financial trading comprising a computer with at least one screen that has both input and output capabilities; graphical software controllable by input to the computer that follows and plots the movement of financial information in a market to the input/output screen; and trading software controllable by the computer and by input from the screen that functionally communicates with the graphical software so that interaction with graphical information on the screen can control the trading software.

The foregoing and other objects and advantages of the invention and the manner in which the same are accomplished will become clearer based on the followed detailed description taken in conjunction with the accompanying drawings in which:

### BRIEF DESCRIPTION OF THE DRAWINGS

FIG. 1 is an exemplary representation of a browser screen used for trading stocks or other financial instruments according to the prior art;

FIG. 2 is an exemplary representation of an average price chart according to the prior art and exemplary of the prior art;

FIG. 3 is an exemplary representation of a browser screen used to make a trade of a security typical of the prior art;

FIG. 4 is an exemplary representation of a trading screen according to the present invention;

FIGS. 5(a) through 5(b) are exemplary portions taken from FIG. 4 and illustrating the interactive nature of the present invention;

FIG. 6 is another partial representation of the screen of FIG. 5;

FIG. 7 is a representation of a portion of the screen of FIG. 4 when a buy order has been placed;

FIG. 8 is another representation of a buy order placed on the screen of the present invention;

FIG. 9 is a representation of the interactive screen of the present invention showing a sell order at a selected price; and

FIG. 10 is another representation of a portion of the interactive screen according to the invention and showing a sell order at a selected price.

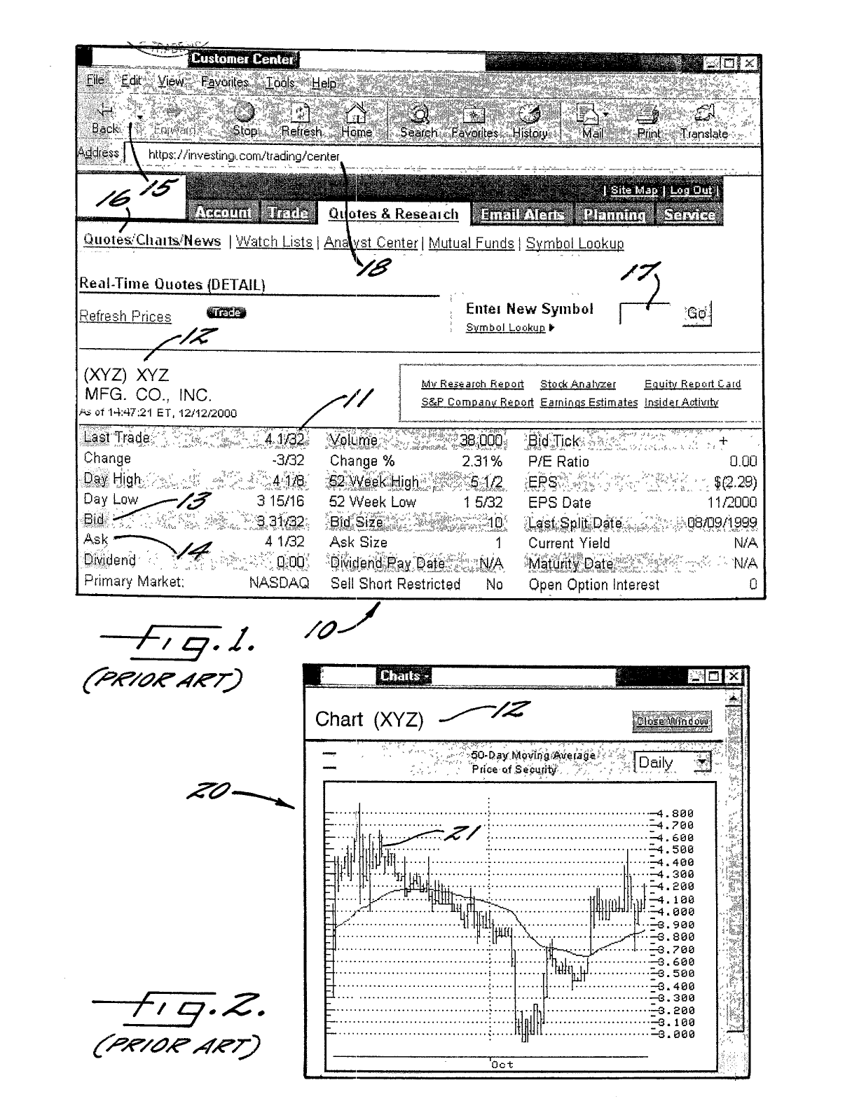

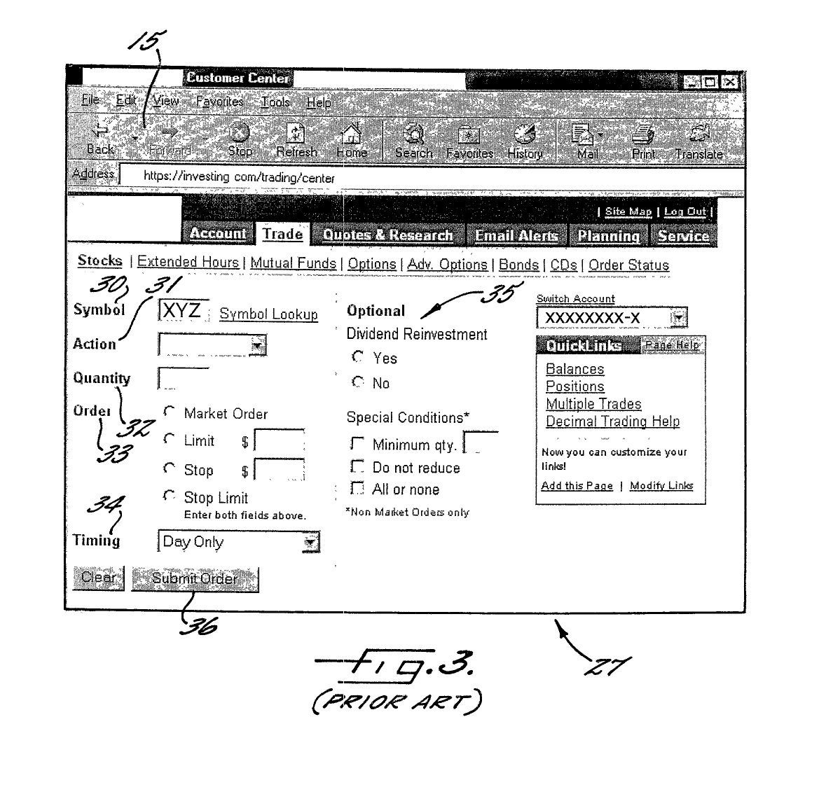

### DETAILED DESCRIPTION

The invention is the combination of trading software, an interactive screen (preferably a touch screen) and software that follows and plots in graphical—as opposed to text-only—fashion the movement of prices in a financial market (e.g. NASDAQ). Using the invention, a trader has the ability to see stock prices (or the prices of other financial instruments) plotted in graphical fashion on a computer screen and to touch the screen at a given point on the plot to generate a buy, sell or other transaction signal. The screen can be touched repeatedly at other points on the graph to initiate other transactions, corresponding either to the first or to other orders that the trader makes. As a result, a trader can visually see the progress of prices in a financial market, initiate an order merely by touching the screen at a point on the graph, review multiple orders in multiple markets on each chart screen, and then close the trades or make a second trade by buying or selling at a later time, again by simply touching the screen at a given price.

The instruments traded are not, of course, limited to stock prices. Other exemplary instruments include (but are not limited to) bonds (government and private), currencies, commodities, and options in these and other instruments. The invention can be used with any or all of these instruments.

There are a large number of vocabulary terms that can be and are used in describing the operation of computer hardware, software, the Internet, and the World Wide Web. In general, terms used herein are used in their generally well-understood sense, and consistent with widely available sources such as Downing, supra, or the Microsoft Computer Dictionary, 4^{th} Ed. (1999) by Microsoft Press, or Freedman, The Computer Desktop Encyclopedia, 2d Ed. (1999), The Computer Language Company, Inc. To the extent that terms are used in other-than-ordinary fashion, their particular meanings will be set forth herein.

Accordingly, as used herein, a “touch screen” is a computer screen designed or modified to recognize the location of a touch on its surface. A touch made to the screen selects or moves a cursor, with the simplest type of touch screen being made up of a grid of sensing lines which determine the location of a touch by matching the coordinates of the vertical and horizontal contacts. Other, and considered more accurate, types of touch screens include an electrically charged surface and sensors around the outer edge of the screen to detect the amount of electrical disruption and pinpoint exactly where contact has been made. Yet another type of touch screen uses infrared light emitting diodes and sensors around the edge of the screen which create an invisible infrared grid which the user's finger (or other object such as a stylus) interrupts in front of the screen. See, e.g. Microsoft Computer Dictionary, supra.

A functionally equivalent device is the light pen, which generally consists of a stylus connected to the computer monitor. When the stylus is pointed at the screen and the user selects items or chooses commands by pressing a clip on the side of the light pen, or by pressing the light pen against the surface of the screen, the selection is made (Microsoft Computer Dictionary).

The invention takes advantage of existing financial software, existing trading software, and existing technology for interactive screen use, and combines these items into an integrated system in which the trader can simply touch the plot of moving stock prices at a desired position to indicate an order. The order remains displayed on the graph as the market continues to move, after which the trader can carry out additional transactions. Many traders desire to carry out multiple trades during the course of a given day simply on the movement of the market, rather than on the underlying financial or economic conditions of a given stock. The invention allows the user to do this simply and graphically with a minimum of data entry input from a keyboard.

In a first embodiment, the invention is a visual-kinesthetic system for financial trading. The system comprises a computer with at least one screen that has both input and output capabilities. Graphical software controllable by input to the computer follows the movement of financial information in a market and plots the movement of the financial information to the input/output screen in charted format. Trading software controllable by the computer and by input from the screen functionally communicates with the graphical software so that interaction with the charted information on the screen can control the trading software.

In particular, the input and output capabilities of the screen are selected to avoid the need for keystrokes. Accordingly, in preferred embodiments, the screen is a touch screen, or a screen that is responsive to a light pen, or a screen that is responsive to a computer mouse. Similarly, other means of input other than keystrokes can be used in accordance with the present invention. For example, if the output of the display was projected (using a common projector for computer screens) onto a digitized pad (such as is often used for drafting purposes), such would be an appropriate embodiment of the input and output capabilities of the screen.

As referred to in the background portion of the specification, the graphical software can plot any desired information with commonly used information, including (but not limited to) price, moving average, bar charts, candlestick charts, convergence, divergence, stochastics, momentum, relative strength, Bollinger bands, and combinations thereof.

In preferred embodiments, the graphical software produces a visual output signal on the screen in response to input to the screen. In other embodiments, the software can produce an audible output signal in response to input to such screen or in response to other information that is being received by the processor or plotted on the screen such as the closing of the trade or the acceptance of an indicated order. Preferably, the software of the system comprises means for marking and confirming a proposed order by touching the screen. In other embodiments, the system can comprise means for marking the order in one position on the screen and confirming the order at a different location on the screen. Alternatively, or in complimentary fashion, the system can include means for touching the screen at a location corresponding to a desired order and means for executing the order only if the chart reaches the desired location. Such will be illustrated herein with respect to the description of the drawings. Thus, as illustrated in the drawings and described later herein, the system comprises means for placing a distinctive symbol on the screen when a user touches (or provides other input) to the screen to indicate an order. Common indications are an up arrow for a buy order, a down arrow for a sell order, different colors for different types of orders, and different colors or orders having different status; e.g., open or closed.

Thus, as further illustrated with respect to the drawings, the system can comprise means for placing a short sell order by touching the screen at a price below the current price to be executed at a specified later time, including a later date, or means for indicating a buy or sell prior to marking the chart to thereby indicate a short or long order.

In preferred embodiments, the trading software comprises means for indicating the number of shares (or other instruments) to be traded; i.e., the size of the order; using input to the screen other than keystrokes.

It will be understood that although the invention is described and claimed with respect to a single screen, that the system can be multiplied as necessary so that a plurality of screens can be connected to the same processor, all with input and output capabilities. Such multiscreen capabilities from a single processor is generally well-established in the art, and is a feature of basic operating systems such as Microsoft's Windows® 98® and its progeny.

Although the invention can be described with respect to both graphical software and trading software, it will be understood that if desired, a single software program can provide both the graphical capabilities as well as the financial trading capabilities, and the invention is not limited to software that must be divided into discreet types of operations.

In another aspect, the invention is a method of financial trading that comprises plotting financial data in graphical format on a screen that has both input and output capabilities other than keystrokes and that is in communication with a computer processor. The method comprises providing input to the screen other than with keystrokes while the data is plotted on the screen to indicate an order, and then forwarding the order indicated by the input from the screen to the processor and from the processor to a trader. As is well understood by those of ordinary skill in this art, and indeed to some extent by lay people, the order can be forwarded to the trader using a “direct” connection or over the global computer network (Internet).

In another aspect, the invention can be understood as a visual kinesthetic system for financial trading that comprises a processor, and input/output screen in communication with the processor that displays information from a financial market in a graphical (charted) format, means in communication with the screen and the processor for forwarding the meaning of the input position on the screen in terms of the displayed information to the processor, means for comparing the input position on the screen to the information displayed on the screen, and means for ordering a transaction based on the relationship between the input position and the displayed information.

Thus, in this aspect, the displayed information could be any of the choices mentioned earlier with the most exemplary being a plot of price versus time. In this aspect, the invention comprises means for ordering a transaction when the display price meets the input price, or for ordering a transaction as soon as the input is made to the screen, or means for ordering a transaction at a set time at the input price.

FIG. 4 illustrates a number of features of the present invention in the form of a combination quote, chart and trading screen 40. The screen 40 and its incorporation into the invention offers a variety of information that is valuable to the trader, and has the capability to help the trader make trades quickly and easily based on the information presented. First, the screen 40 includes a textual information line 41, which shows the stock symbol, the date, and the “O/H/L/C” prices, which correspond to the opening, daily high, daily low, and closing price of the indicated stock.

This information is also given as the ordinate 42 that presents the price information for the stock symbolized in line 41 on both a day-by-day basis and over a range of dates. FIG. 4 illustrates the daily price information as a series of vertical bars 43 that visually indicate the high and low prices for the stock on a given date. In turn, the date is given along the abscissa 44, which in FIG. 4 is shown on a daily basis. It will be understood, of course, that the chart can be presented in any number of relative time frames, and that the use of a day-by-day chart is illustrative rather than limiting of the present invention.

The bottom half of the screen chart provides the information about the number of shares of the stocks that have been traded on a given day (“volume”), and using the same abscissa 44 as does the bar chart 43.

FIG. 4 also shows a buy command 45, a sell command 46, and a diagram 47 that can be used in conjunction with the touch screen of the invention to order commonly recognized amounts of shares. Furthermore, after the trader touches the buy or sell commands 45 or 46, the number of shares command, and the screen at the point corresponding to the price desired, the software computes the order summary on sub-screen 50, so that the information is presented both textually and graphically. The same touch screen capabilities can also be used to preview the order 51, clear the order 52, or execute the previewed order 53. As is the case with other types of screens of this nature, the screen can typically demonstrate the account type or account number 54, from which the funds are to be taken, and will assign an order number 55 to the transaction.

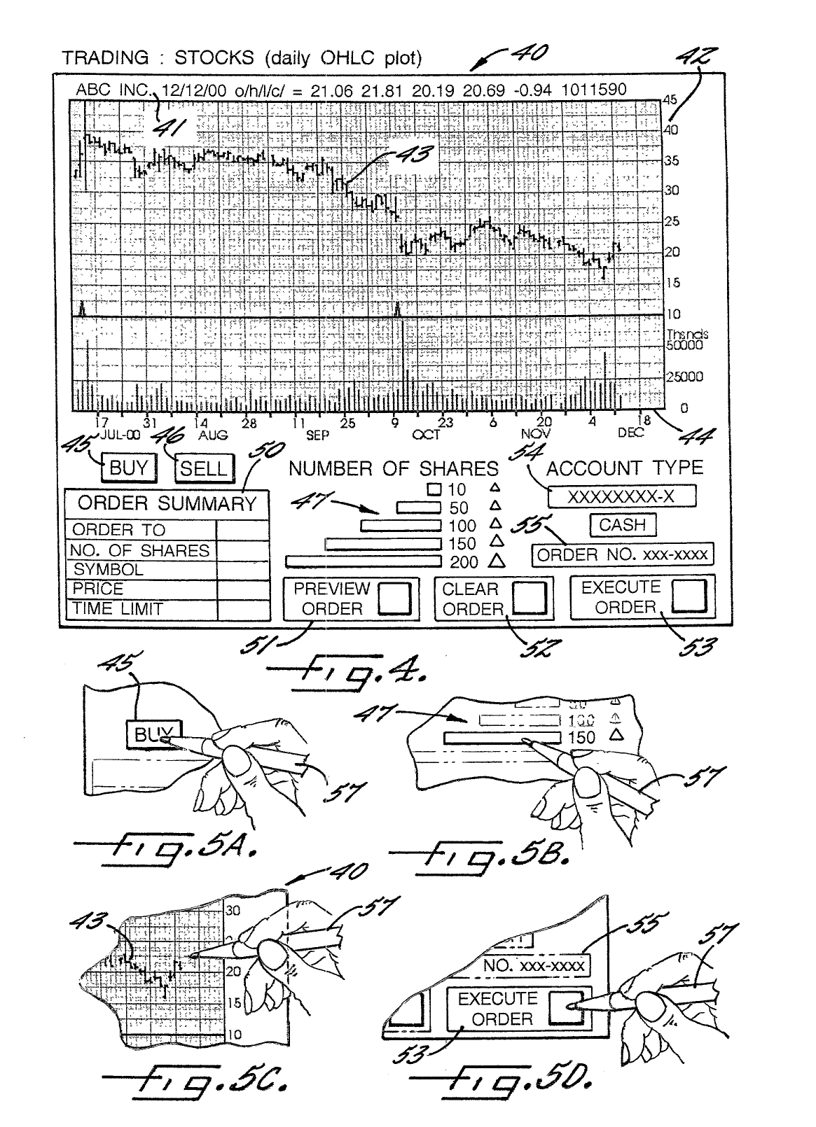

FIGS. 5A-5D illustrate the physical steps that can be used to quickly and easily place an order using the present invention. Each of FIGS. 5A-5D illustrate a stylus 57 that can be used to manipulate the touch screen. It will be understood, however, that a stylus is simply an alternative method of touching a particular point on a touch screen, and whenever the necessary precision can be obtained by touching a larger screen with one's finger or some other larger device, the same falls within the invention. Accordingly, the stylus 57 is an illustrative embodiment of the invention rather than a limiting one.

FIG. 5A illustrates the stylus 57 being used to touch the buy command button 45. This initiates the software's recognition of the transaction about to take place. Following the order to buy or sell, the stylus 57 is next used to order a quantity of shares. FIG. 4 generally illustrates a selection of quantities of 10, 50, 100, 150 and 200 shares, but will be understood that the way in which the number of shares can be ordered is not limited to these particular selections. Additionally, with text recognition software (handwriting), the stylus or other instrument could also be used to simply write the number of shares desired in an appropriate input box on the screen 40.

Having chosen to buy a specific quantity of shares, Figure C illustrates that the next step is to touch the screen at a particular price. As will be discussed with respect to FIGS. 7 through 10, the price at which the screen is touched, when combined with the order to buy or sell, establishes the particular type of order being placed.

The order of touch is not critical, other than when previewing or executing the order. Thus, the screen can be touched first to select a price, following which the quantity can be touched to complete the input step.

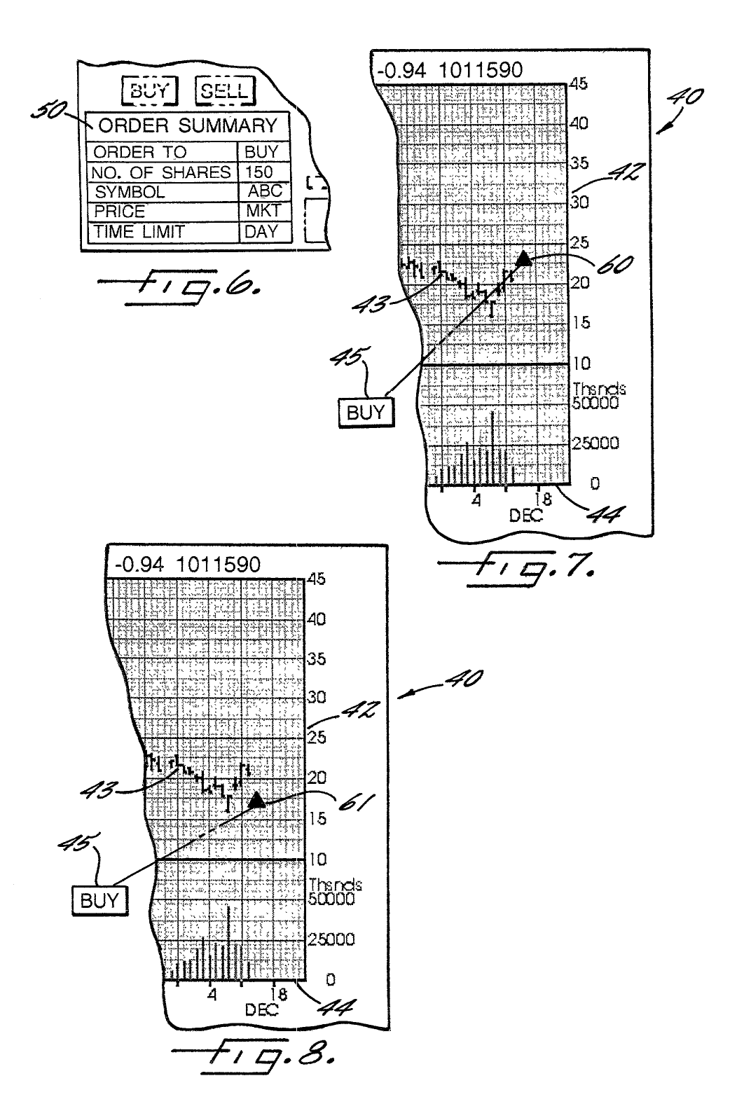

Having completed the steps illustrated in FIGS. 5A through 5D, the next screen next displays (FIG. 6) the order summary subscreen 50 with the information just placed by the trader: the buy order, the number of shares, the stock selected, the price and the time limit. If these are satisfactory (and the use of the screen 50 is essentially optional), the next step is to execute the order using the execute order box 53 (Figure SD).

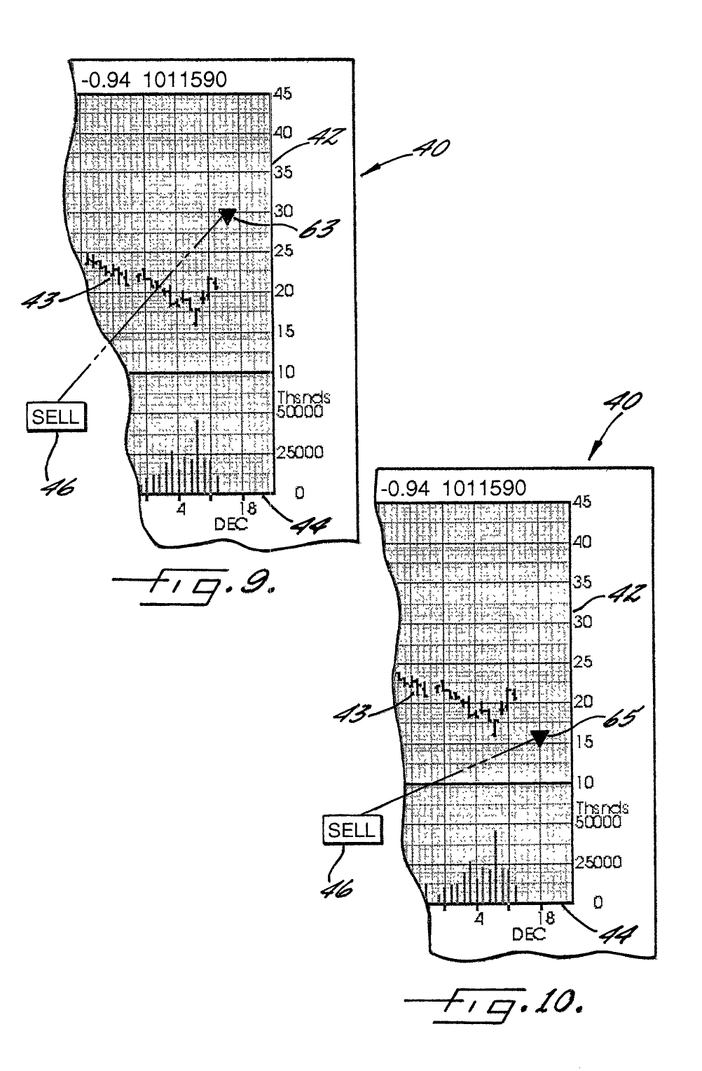

FIGS. 7 through 10 illustrate in greater detail some of the kinesthetic aspects of the invention. FIGS. 7 and 8 show the situation after the trader has executed a buy order by touching the buy command button 45 and then by touching the screen at the point, illustrated by the up arrow 60 in FIG. 7, representing the desired price. As illustrated, the resulting symbol that the software places on the interactive touch screen is in the form of an up arrow, which is conventionally understood by traders to represent a buy order. By setting the price, the trader in effect likewise defines, to an entire or at least partial extent, the type of trade being ordered. In particular, FIG. 7 illustrates a “stop” order, which indicates a request to buy or sell at the market price, but only when the security reaches or passes the specified price that is referred to as the stop price. Once the stop price moves through the stop price, the stop order becomes a market order, which guarantees execution of the trade, but not the price.

In the same manner, FIG. 8 indicates a buy limit order, which represents a request to buy at the price specified or better. Execution of a limit order is not guaranteed, but if executed, the price or better is guaranteed.

FIGS. 9 and 10 illustrate similar information for selling orders. Both of these figures illustrate the sell command button 46 and respective sell symbols 63 (FIG. 9) and 65 (FIG. 10). Because these are sell orders, the command in FIG. 9 to sell at a price higher than the present price represents a limit order, while the order 65 in FIG. 10, being below the current selling price, represents a stop order.

The invention has been described in detail, with reference to certain preferred embodiments, in order to enable the reader to practice the invention without undue experimentation. A person having ordinary skill in the art will readily recognize that many of the components and parameters may be varied or modified to a certain extent without departing from the scope and spirit of the invention. Furthermore, titles, headings, or the like are provided to enhance the reader's comprehension of this document and should not be read as limiting the scope of the present invention.

That which is claimed is:

1. A visual-kinesthetic system for financial trading comprising:
a computer with at least one screen that has both input and output capabilities;
graphical software controllable by input to said computer that follows the movement of financial information in a market and plots the movement of the financial information to said input/output screen in charted format; and
trading software controllable by said computer and by input from said screen that functionally communicates with said graphical software so that interaction with said charted information on said screen can control said trading software.

2. A financial trading system according to claim 1 wherein said screen is a touch screen.

3. A financial trading system according to claim 1 wherein said screen is responsive to a light pen.

4. A financial trading system according to claim 1 wherein said screen is responsive to a computer mouse.

5. A financial trading system according to claim 1 wherein said screen comprises a digital pad and means for projecting the financial information onto said digital pad.

6. A financial trading system according to claim 1 wherein said graphical software plots information selected from the group consisting of: price, moving average, bar charts, candlestick charts; convergence, divergence, stochastics, momentum, relative strength, Bollinger bands, and combinations thereof.

7. A financial trading system according to claim 1 wherein said graphical software produces a visual output signal on said screen in response to input to said screen.

8. A financial trading system according to claim 1 wherein said graphical software produces an audible output signal in response to input to said screen.

9. A financial trading system according to claim 1 comprising means in said software for marking and confirming a proposed order by touching said screen.

10. A financial trading system according to claim 9 comprising means for marking the order at one position on said screen and confirming the order at a different location on said screen.

11. A financial trading system according to claim 1 comprising:
means for touching said screen at a location corresponding to a desired trade; and
means for executing the trade only if the chart reaches the desired location.

12. A financial trading system according to claim 1 comprising means for placing a distinctive symbol on said screen when the user provides input said screen other than keystrokes to indicate an order.

13. A financial trading system according to claim 12 wherein said symbol is an up arrow for a buy order.

14. A financial trading system according to claim 12 wherein said symbol is a down arrow for a sell order.

15. A financial trading system according to claim 12 wherein said symbol-placing means comprises a display of different colors for different types of orders.

16. A financial trading system according to claim 12 wherein said symbol-placing means comprises a display of different colors for different order status.

17. A system according to claim 12 comprising means for changing the color of said symbol when the pending order is completed.

18. A financial trading system according to claim 1 comprising means for placing a short sell order when the user touches the screen at a price below the current price to be executed at a specified later time.

19. A financial trading system according to claim 1 comprising means for indicating a buy or sell prior to marking the chart to thereby indicate a short or long order.

20. A financial trading system according to claim 1 wherein said trading software comprises means for indicating the number of shares to be traded using input to said screen other than keystrokes.

21. A financial trading system according to claim 1 comprising a plurality of said screens with input and output capabilities.

22. A visual-kinesthetic system for financial trading comprising:
a computer with at least one screen that has both input and output capabilities; and
software controllable by input to said computer that carries out at least the functions of following and plotting the movement of financial information in a financial market in charted format to said input/output screen; and
placing trading orders based on input to the computer through said screen.

23. A financial trading system according to claim 22 wherein said screen is selected from the group consisting of touch screens, screens that are responsive to a light pen, screens that are responsive to a computer mouse, digital pads, and combinations thereof.

24. A financial trading system according to claim 22 wherein said graphical software plots information selected from the group consisting of: price, moving average, bar charts, candlestick charts; convergence, divergence, stochastics, momentum, relative strength, Bollinger bands, and combinations thereof.

25. A financial trading system according to claim 22 wherein said graphical software produces a visual output signal on said screen in response to input to said screen.

26. A financial trading system according to claim 22 wherein said graphical software produces an audible output signal in response to input to said screen.

27. A financial trading system according to claim 22 comprising means in said software for marking and confirming a proposed order by providing input to said screen other than from keystrokes.

28. A financial trading system according to claim 27 comprising means for marking the order at one position on said screen and confirming the order at a different location on said screen.

29. A financial trading system according to claim 22 comprising:
means for providing input to said screen other than with keystrokes at a location corresponding to a desired trade; and
means for executing the trade only if the chart reaches the desired location.

30. A financial trading system according to claim 22 comprising means for placing a distinctive symbol on said screen when the user touches said screen to indicate an order.

31. A financial trading system according to claim 30 wherein said symbol is selected from the group consisting of an up arrow for a buy order, a down arrow for a sell order, a display of different colors for different types of orders, a display of different colors for different order status, and combinations thereof.

32. A financial trading system according to claim 22 wherein said trading software comprises means for indicating the number of shares to be traded using input to said screen other than keystrokes.

33. A financial trading system according to claim 22 comprising a plurality of said screens with input and output capabilities.

34. A method of financial trading comprising:
plotting financial data in graphical format on a screen that has both input and output capabilities other than keystrokes and that is in communication with a computer processor;
providing input to the screen other than with keystrokes while the data is plotted thereon to indicate an order; and
forwarding the order indicated by the input from the screen to the processor and from the processor to a trader.

35. A method of financial trading according to claim 34 wherein the step of providing input to the screen is selected from the group consisting of: touching a touch screen, directing a light pen to said screen, and directing a computer mouse.

36. A method of financial trading according to claim 34 wherein the step of plotting financial data comprises plotting information selected from the group consisting of: price, moving average, bar charts, candlestick charts; convergence, divergence, stochastics, momentum, relative strength, Bollinger bands, and combinations thereof.

37. A method of financial trading system according to claim 34 comprising touching the screen to mark and confirm a proposed order.

38. A method of financial trading according to claim 34 comprising touching the screen at a price below the current price to be executed at a specified later time to place a short sell order.

39. A method of financial trading according to claim 34 comprising indicating a buy or sell prior to marking the chart to thereby indicate a short or long order.

40. A method of financial trading according to claim 34 comprising indicating the number of shares to be traded using input to said screen other than keystrokes.

41. A visual-kinesthetic system for financial trading comprising:
a processor;
an input/output screen in communication with said processor that displays information from a financial market in a graphical format;
means in communication with said screen and said processor for forwarding the meaning of an input position on said screen in terms of the displayed information to said processor;
means for comparing the input position on said screen to the information displayed on said screen; and
means for ordering a transaction based on the relationship between the input position and the displayed information.

42. A visual-kinesthetic trading system according to claim 41 wherein the displayed information is a plot of price versus time.

43. A visual-kinesthetic trading system according to claim 42 comprising means for ordering a transaction when the displayed price meets the input price.

44. A visual-kinesthetic trading system according to claim 42 comprising means for ordering a transaction as soon as input is made to said screen.

45. A visual-kinesthetic trading system according to claim 42 comprising means for ordering a transaction at a set time at the input price.

46. A visual-kinesthetic trading system according to claim 42 wherein said communication means comprises software.

47. A visual-kinesthetic trading system according to claim 42 wherein said comparing means comprises software.

48. A visual-kinesthetic trading system according to claim 42 wherein said ordering means comprises software.

49. A visual-kinesthetic trading system according to claim 42 comprising graphical software for plotting information selected from the group consisting of: price, moving average, bar charts, candlestick charts; convergence, divergence, stochastics, momentum, relative strength, Bollinger bands, and combinations thereof.

50. A financial trading system according to claim 41 comprising means for placing a distinctive symbol on said screen when the user touches said screen to indicate an order.

51. A financial trading system according to claim 50 wherein said symbol is selected from the group consisting of an up arrow for a buy order, a down arrow for a sell order, a display of different colors for different types of orders, a display of different colors for different order status, and combinations thereof.

52. A financial trading system according to claim 41 wherein said communications means comprises means for indicating the number of shares to be traded (i.e., the size of the order) using input to said screen other than keystrokes.

53. A financial trading system according to claim 41 comprising a plurality of said screens with input and output capabilities.
